(19) United States
(12) Patent Application Publication
(10) Pub. No.: US 2009/0070166 A1
(43) Pub. Date: Mar. 12, 2009

(54) METHOD AND SYSTEM FOR MITIGATING LIABILITY RELATED TO REGULATORY REQUIREMENTS

(76) Inventors: Kevin Lashus, Austin, TX (US); Robert F. Loughran, Austin, TX (US); James McGarvey, Houston, TX (US)

Correspondence Address: PATTERSON & SHERIDAN, L.L.P., 3040 POST OAK BOULEVARD, SUITE 1500, HOUSTON, TX, 77056, US

(21) Appl. No.: 11/854,507

(22) Filed: Sep. 12, 2007

(51) Int. Cl. G06Q 10/00

(52) U.S. Cl. 705/7

(57) ABSTRACT

Embodiments of the invention may be used to mitigate potential liability for non-compliance with legal requirements related to employment authorization and verification. In one embodiment, a method is used to digitize employment verification forms, to create a database of the information reflected in the paper employment verification forms, and to identify errors in the employment verification forms, while concurrently limiting both the potential for unwanted disclosure of employee personal data and the potential for increased employer liability due to “knowledge” of problematic or incorrect employment verification form data.

### BACKGROUND OF THE INVENTION

1. Field of the Invention

Embodiments of the present invention generally relate to a method for an employer to comply with regulatory requirements, mitigate potential liabilities for non-compliance, while simultaneously safeguarding privacy concerns related to employee identifying information.

2. Description of the Related Art

Under United States law, an employer is required to take steps to document that each employee is authorized to work in this country. Further, an employer may face civil, and in some cases, criminal liability for non-compliance. Under current legal requirements, an employer and employee each complete portions of a government-issued form on an employee's first day at work. Typically, the employer interviews an employee on the first day of employment. Currently, the employee completes one section of what is referred to as an Employment Eligibility Verification Form I-9 (OMB No. 1615-0047) (Rev. May 31, 2005). On the I-9 form, the new employee elects their status as a valid worker in the United States, whether as a United States citizen, a lawful permanent resident, or an employment-authorized alien. Additionally, the employer is required to document that the new employee presented documentation supporting the election. Once completed, the employer is required to retain completed I-9 forms for three years after an employee's date of hire or one year after employment ends, whichever is later. Although the particulars of the I-9 form or requirements for time keeping may change, it is anticipated that the general legal requirement—that the employer is responsible to document the legal status of each employee—will persist for sometime into the future.

It is unlawful for an employer to knowingly employ a person who is not authorized by the government to work or to continue to employ an individual once the employer learns hat the employee is not working legally. Additionally, an employer's actual (or constructive) knowledge of substantive or technical violations with an I-9 form may satisfy the standard required to impose civil (or criminal) penalties on the employer. Further, failing to ensure that the I-9 forms are being completed correctly may lead to an audit and worksite enforcement investigation by government officials. These audits frequently turn into criminal investigations and lead to harsh penalties. Accordingly, it is in an employer's best interest to ensure that both employees and employer representatives properly complete the I-9 forms. Thus, many employers have methods in place in an effort to ensure that new employees complete the I-9 form correctly, that the proper documentation is presented to the employer, and that the both the employee and employer complete their respective portions of the I-9 correctly. Unfortunately, in-practice, the procedures put in place by employers often fail to ensure that the I-9 form is completed correctly, by the employee, the employer, or both.

As it stands, employers currently face many challenges in complying with the I-9 process. Mistakes and misunderstanding of the law are quite common. In some cases, a new employee may write information in the wrong space provided by the form. An employee may misunderstand his employment status and may confuse the types of documents that may be used to support their election, or not provide the correct supporting documents. Similarly, new employees frequently supply an incorrect date in a field of the form or skip form fields all together. Mistakes are also common on the employer's side of the I-9 process. For example, employers may forget to sign or date I-9 forms, an employer may have failed to certify the date of employment. And sometimes employers fail to document the employee's offered documentation in support of their status election.

Another challenge for the employer relating to this process results from the information found in an I-9 form. The simple fact is that each I-9 form includes highly confidential information subject to misuse. Primarily, information that could be used to commit identify theft. Further, I-9 forms are protected by other laws including, the Privacy Act of 1984 as well as the Computer Matching and Privacy Act of 1988. Thus, employers have a strong incentive to take steps to prevent the inappropriate disclosure or misuse of confidential information captured on the I-9 form.

Further problems arise when an employer becomes aware (or reasonably should be aware) of a problem I-9 form and fails to take any corrective action. This may occur in both processing I-9 forms for new employees as well as in auditing I-9 forms stored for active and previous employees. This may result in a worksite enforcement audit of the employer by the government, and possibly, a criminal investigation. At the same time, for large employers with thousands of employees, and possibly high rates of employee turnover, managing compliance with the I-9 requirements, as well as mitigating issues of non-compliance, can be both difficult and expensive. Further, given the contingent liabilities involved with the disclosure or misuse of employee data, some employers are simply ignoring the issues altogether. Even more dangerous is at times employers attempt to mitigate problems with I-9 compliance by performing a self audit without proper legal guidance and advice. In these cases, an employer, often not aware of the consequences of their actions, may fail in their attempts to mitigate exposure, leaving them with greater potential liability based on the knowledge of problematic I-9 forms uncovered during such an audit.

Accordingly, what is needed is a method for mitigating employer liability associated with the regulatory requirements discussed above.

### SUMMARY OF THE INVENTION

Present embodiments may be used to limit liability of an employer during employment authorization and verification through a method digitizing paper forms and identifying errors in the forms. In one embodiment, a legal services entity may be contracted to perform an audit of all the I-9 forms then in the possession of the employer. The legal services entity may digitize the I-9 forms, create a database of the information reflected in the paper I-9 forms, and identify errors in the I-9 forms. At the same time, security measures are used to limit both the potential for unwanted disclosure of employee personal data and the potential for increased employer liability due to “knowledge” of problematic or incorrect I-9 form data. Representatives of the law firm may sort the I-9 forms by active and separated employees, scan the forms to create an electronic copy of the forms, and enter the form data for each I-9 form into a secure database. Further, the entire process of may be performed within a secure environment, minimizing the potential for the misuse of identifying personal information reflected in the forms. After the I-9 forms are digitized, the paper copies may be destroyed.

One embodiment includes a method for mitigating an employer's potential liability exposure based on errors in regulatory documents required to be kept by the employer. The method may generally include, receiving a plurality of documents, wherein each document represents an employee of the employer and includes personally identifying information related to the employee. The method may also include generating at least one electronic record for each of the plurality of documents, where the electronic record captures the information recorded on one of the plurality of documents related to one of the employees. The method may also include evaluating the captured information in the electronic records for compliance with a regulatory requirement imposed on the employer, and for each electronic record representing one of the documents with information determined to comply with the regulatory requirement, the electronic record is stored in a first collection of electronic records. For each electronic record representing one of the documents with information determined to not comply with the regulatory requirement, the method may also include, identifying an error in the captured information of the electronic record and determining whether the error in the captured information may be mitigated through a corrective action performed by the employer. If the error may be mitigated, the electronic record is stored in a second collection of electronic records along with a recommendation for a corrective action to be performed by the employer.

### BRIEF DESCRIPTION OF THE DRAWINGS

So that the manner in which the above recited features of the present invention can be understood in detail, a more particular, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram illustrating a client server view of a secure computing environment and database system, according to one embodiment.

FIG. 2 is a conceptual illustration of a secure data entry area, according to one embodiment.

FIG. 3 illustrates a method for performing an audit of I-9 forms to mitigate an employer's potential liability exposure based upon improperly completed (or improperly documented) I-9 forms, according to one embodiment.

FIG. 4 is a flow diagram illustrating a data entry process, according to one embodiment.

FIG. 5 is a conceptual illustration of document and information flow between an employer and a legal services entity, according to one embodiment.

FIG. 6 illustrates a screenshot of a login screen for a data entry terminal, according to one embodiment.

FIG. 7 illustrates an example screenshot of a data entry screen, according to one embodiment.

FIG. 8 illustrates an example screenshot of a successfully completed data entry screen, according to one embodiment.

FIG. 9 illustrates an example of a screenshot for a problem I-9 form, according to one embodiment.

FIG. 10 illustrates an example of the screenshot of the problem I-9 form from FIG. 9 after being notated to indicate a specified error, according to one embodiment.

FIG. 11 illustrates an example screenshot of an I-9 form after being notated to indicate a potential inaccuracy, according to one embodiment.

FIG. 12 is a conceptual illustration of a process for transporting digital scans of I-9 forms from a general computer into a secure server, according to one embodiment.

### DETAILED DESCRIPTION

Embodiments of the present invention may be used by an employer to mitigate potential liability for non-compliance with legal requirements related to employment authorization and verification. In one embodiment, a method is used to digitize I-9 forms, to create a database of the information reflected in the paper I-9 forms, and to identify errors in the I-9 forms, while concurrently limiting both the potential for unwanted disclosure of employee personal data and the potential for increased employer liability due to “knowledge” of problematic or incorrect I-9 form data. I-9 forms and supporting documents may be collected and delivered to a legal services entity (e.g., a law firm). Representatives of the law firm may sort the I-9 forms by active and separated employees, scan the forms to create an electronic copy of the forms, and enter the form data for each I-9 form into a secure database. Further, the entire process of may be performed within a secure environment, minimizing the potential for the misuse of identifying personal information reflected in the forms. After the I-9 forms are digitized, the paper copies may be destroyed.

Note however, although embodiments are described herein relative to the current I-9 form and legal requirements, one of ordinary skill in the art will recognize that the methods described herein may be adapted for use with changes to the I-9 form and changes to the legal requirements related to employment authorization and verification. Further, embodiments may be adapted for use with other legal regimes where compliance with such regimes is predicated on forms containing personally identifying information.

Furthermore, the following description references embodiments of the invention. However, it should be understood that the invention is not limited to any specifically described embodiments. Instead, any combination of the following features and elements, whether related to different embodiments or not, is contemplated to implement and practice the invention. Furthermore, in various embodiments the invention provides numerous advantages over the prior art. However, although embodiments may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

One embodiment is implemented as a program product for use with a computer system. The program(s) of the program product defines functions of the embodiments (including the methods described herein) and can be contained on a variety of computer-readable media. Illustrative computer-readable media include, but are not limited to: (i) non-writable storage media on which information is permanently stored (e.g., read-only memory devices within a computer such as CD-ROM or DVD-ROM disks readable by a CD-ROM or DVD-ROM drive); (ii) writable storage media on which alterable information is stored (e.g., floppy disks within a diskette drive, hard-disk drives, or flash memory devices). Other media include communications media through which information is conveyed to a computer, such as through a computer or telephone network, including wireless communications networks. The latter embodiment specifically includes transmitting information to/from the Internet and other networks. Such computer-readable media, when carrying computer-readable instructions that direct the functions of the present invention, represent embodiments of the present invention.

In general, the routines executed to implement the embodiments may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific. However, it should be appreciated that any particular program nomenclature that follows is used merely for convenience, and thus the invention should not be limited to use solely in any specific application identified and/or implied by such nomenclature.

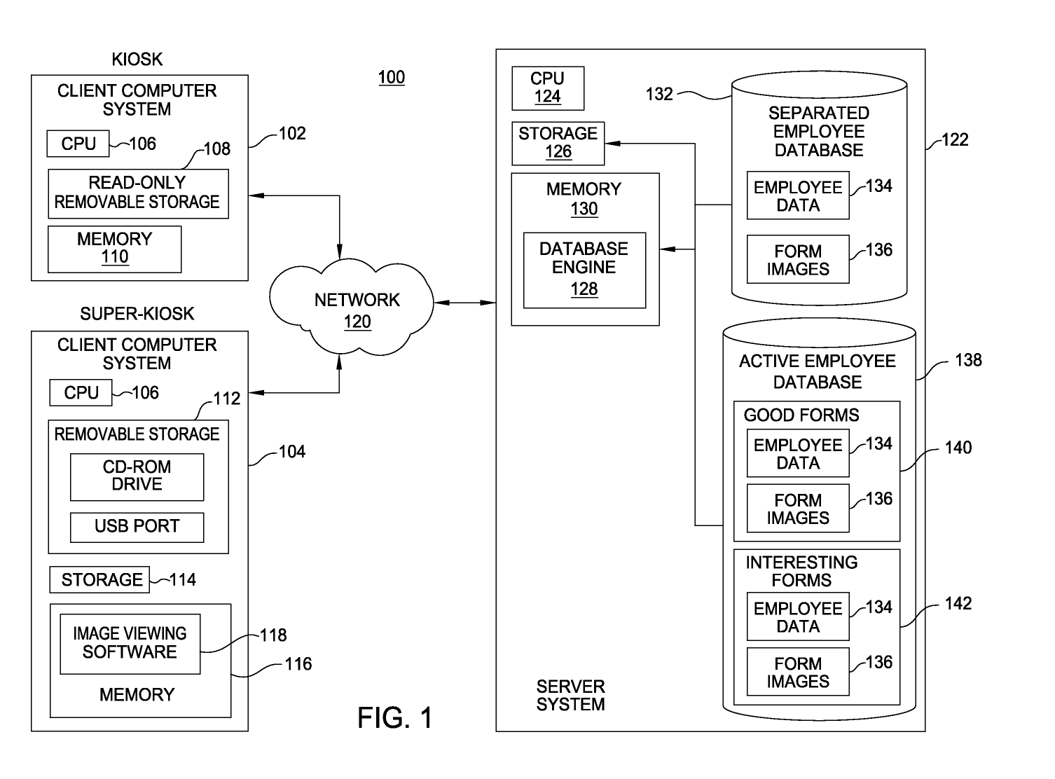

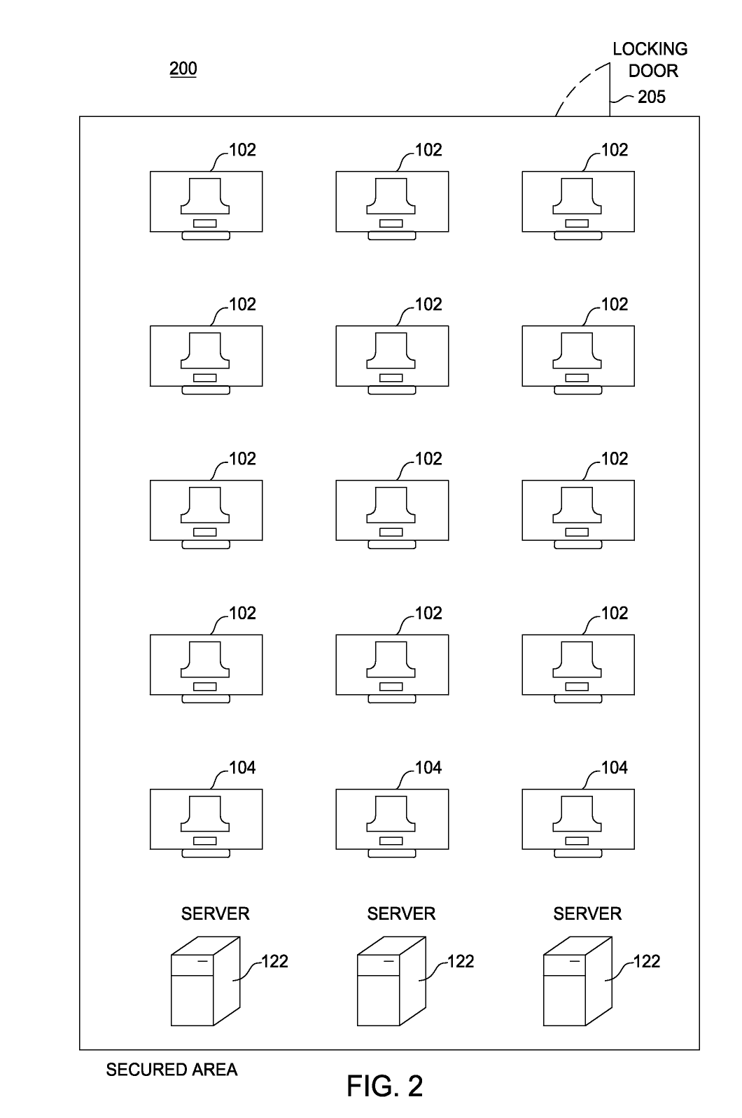

One embodiment includes a method for auditing I-9 forms using a combination of a secure computing environment and a secure physical environment. FIG. 1 illustrates elements of a secure computing environment used for data entry and evaluating content of I-9 forms, and FIG. 2 illustrates elements of a corresponding secure physical environment. As described herein, the secure computing environment and the secure physical environment may be used to evaluate a given employer's compliance with regulatory requirements, as reflected in a collection of employee I-9 forms. By identifying I-9 forms with problems that may be mitigated, an I-9 audit conducted according to an embodiment of the invention may substantially reduce a given employer's exposure to civil (or criminal) liability. At the same time, conducting the data entry using the secure computing and physical environments safeguards the personal information reflected in the collection of I-9 forms.

Further, once the audit is complete, the employer may be provided with a set of CDs with information identifying I-9 forms with problems that may be mitigated and instructions for mitigating the problems, a set of CDs with information identifying I-9 forms with uncorrectable errors, a set of CD's containing encrypted I-9 forms data for separated employees. As the time period expires for retaining I-9 forms for separated employees (currently three years or one year from a separation date, whichever is later), CDs from the latter set may be destroyed, absolving the employer of any liability exposure for problematic I-9s on a given CD. Further still, as the results of the I-9 audit are provided in an encrypted form, the employer may be able to argue that it lacked any interim knowledge of problematic I-9 forms.

FIG. 1 is a block diagram illustrating a client server view of a secure computing environment 100 and database system, according to one embodiment of the invention. As shown, secure computing environment 100 includes a network 120, a secure server system 122, and two types of client computer systems: a kiosk 102 and a super-kiosk 104. Data entry personnel may interact with the kiosk 102 to enter data on I-9 forms, and firm personnel (or other trusted individuals) may interact with the super-kiosk 104.

In one embodiment, kiosk 102 provides the data entry personnel with limited computing functionality. For example, kiosk 102 may provide a stripped down computing system that limits the actions of data entry personnel to accomplishing the limited task of entering data from I-9 forms into a database. Accordingly, as shown, kiosk 102 includes only a CPU 106, memory 110, and read-only removable storage 108. CPU 106 is a programmable logic device that performs all the instructions logic, and mathematical processing performed in executing user applications (e.g., image viewing software 118). Removable storage 108 may be a CD ROM drive. Importantly, kiosk 102 may intentionally lack any writable storage devices or the capability to connect to writable storage devices (e.g., USB ports used to connect a flash memory device, media player, or portable disk drive). Doing so may prevent data entry personnel from surreptitiously recording identification data reflected in I-9 forms. Further, data entry personnel may use a serialized boot CD to boot a stripped down operating system on kiosk 102. Such a serialized boot CD may be configured boot kiosk 102 and to execute a software application used to display scanned I-9 forms and allow data entry personnel to perform data entry functions, while also preventing the data entry personnel from executing any unauthorized software applications.

Like kiosk 102, super-kiosk 104 provides a computing system having a CPU 106, non-removable storage 112, and a memory 116. However, super-kiosk 104 may also include writeable storage such as a USB flash memory device or portable disk drive connected to USB ports. Further, super-kiosk 104 may also include integrated storage 114 such as a hard disk drive. Illustratively, memory of the super-kiosk 104 includes image viewing software 118. Trusted personnel may interact with the super-kiosk 104, and manage the activity data entry personnel. Trusted personnel are allowed limited access to the secure network in order to migrate the scanned images directly to the secure database. For example, super-kiosk 104 may be configured to allow trusted personnel to view scanned I-9 forms and entered data related to each scanned I-9 form.

In one embodiment, the kiosk 102 and super-kiosk 104 are connected to a secure server system 122 across network 120. As shown, the server system 122 includes a CPU 124, storage 126, and a memory 130 storing a database engine 128. The database engine 128 may be used to create, retrieve, update and delete data from databases 132 and 138, and may also be used to perform other database operations. Illustratively, server system 122 stores two databases: a separated employee database 132 and an active employee database 138. Databases 132 and 138 may be used to store data captured from I-9 forms of employees. For example, data entry personnel may interact with kiosks 102 to view a scanned image of an I-9 form and to record the substantive information in the fields of the I-9 forms then stored in database 132 and 138.

In one embodiment, the separated employee database 132 may include separated employee data 134, such as start date, separation date, as well as information found on a given employee's I-9 form. The separated employee database 132 may also include scanned images of each separated employee's I-9 form along with scanned images of any supporting documents (if available). As shown, active employee database 138 includes two mailboxes: a mailbox 140 for “good” I-9 forms and a mailbox 142 for “interesting” or “problem” I-9 forms. The “good” I-9 forms generally represent forms with no readily apparent errors or missing information, “interesting” I-9 forms generally represent forms requiring difficult analysis or requiring a consensus building or I-9 forms which represent liability which may not be mitigated, and the “problem” I-9 forms generally represent forms with clear errors. It is from the secured mailboxes 140 and 142 from which the firm is able to review the scans for suggested correction. Further, mailboxes 140 and 142 are shown to include two sets of data: employee data 134 and form images 136. Employee data 134 may include data entered manually from a given employee's I-9 form, and form images 136 may include scanned images of I-9 forms as originally submitted by an employer, along with images of any supporting documents the employee has submitted in support of that I-9 form.

FIG. 2 is a conceptual illustration of a secure area 200, according to one embodiment of the invention. In one embodiment, contracted data entry personnel (referred to herein as “contractees”) enter data from I-9 forms for employees in secure entry area 200 using one of kiosks 102. Additionally, trusted personnel may use super-kiosks 104 present in secure area 200 to review scanned images of I-9 forms. As described in more detail below, the trusted personnel may also distribute paper I-9 forms to contractees, collect the same forms once the data entry process is complete, and manage access by the contractees to the kiosks 102. In one embodiment, the door 205 may remain locked when the secure area 200 is not in use. Further, trusted personnel may be present when data entry personnel are actively processing I-9 forms to ensure that such I-9 forms are handled properly.

Contractees may be prohibited from bringing any device into the secure area 200 which could be used to surreptitiously record personal information found on an I-9 form or other supporting documentation. This may include prohibiting items such as cell phones and cameras, but may also include non-electronic items such as pen and paper. Similarly, at the end of a working period, contractees may be prohibited from removing anything from the secure area 200 and may be required to accounts for I-9 forms distributed to them for data entry.

As described in conjunction with FIG. 1, kiosks 102 may include a minimal computing system configured to restrict the use of such system to the use of an I-9 data entry program. Thus, data entry personnel may be unable to use the kiosks 102 for other purposes, including recording personally identifying information reflected in an I-9 form, since they contain no storage and limited memory.

As shown, secure area 200 may also include one or more super-kiosks 104, used by trusted personnel. Super-kiosks 104 may provide more functionality than the kiosks 102, but are password protected to prevent access by unauthorized users. In one embodiment, trusted personal may interact with a viewing application 118 executing on super-kiosks 104 to review images of I-9 forms and to notate different types of errors that appear on a given I-9 form. Also as shown, the secure area 200 includes servers 122, which store the databases of scanned I-9 forms as well as database records reflecting the substantive content of each scanned I-9 form. In one embodiment, kiosks 102, super-kiosks 104, and servers 122 are interconnected via a network. However, servers 122 may not be accessible through any network external to the secure area 200.

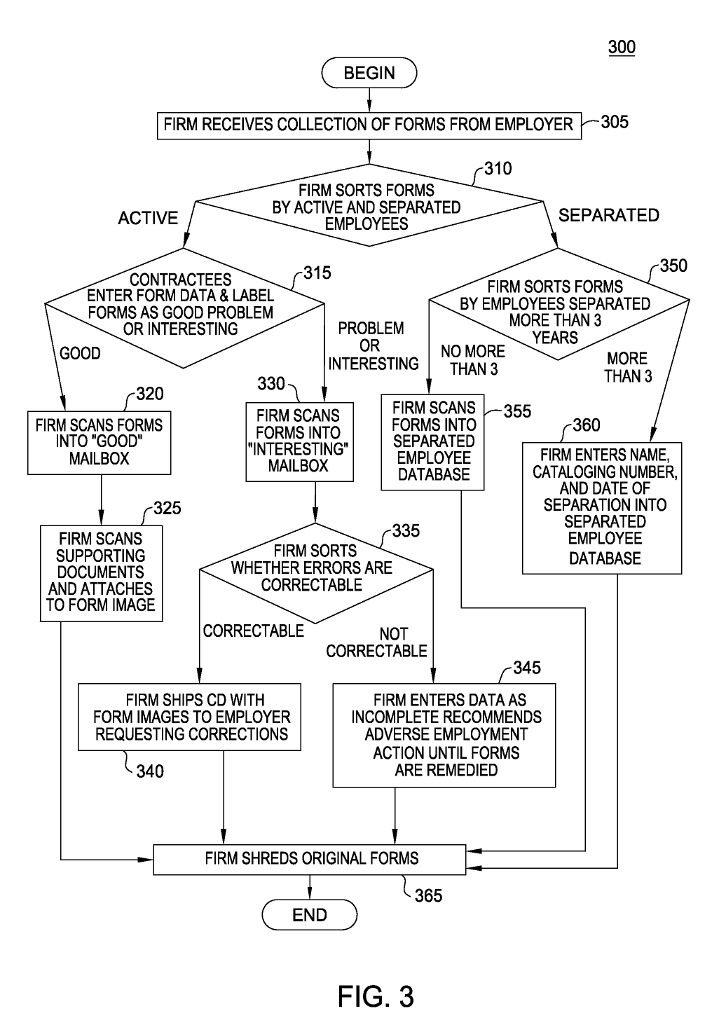

FIG. 3 illustrates a method 300 for performing an audit of I-9 forms to mitigate an employer's potential liability exposure based upon improperly completed (or improperly documented) I-9 forms, according to one embodiment of the invention. As shown, the method 300 begins at step 305, where a firm receives a collection of I-9 forms (and any supporting documents). For example, an employer may contract with a law firm to provide a comprehensive review of potential liability exposure related to I-9 form compliance. In such a case, the employer may provide the law firm with each I-9 form (and any supporting documents) currently in the employer's possession, along with data related to which employees are currently employed and which employees have separated from employment.

At step 310, the firm may sort the I-9 forms by active and separated employees. At step 315, once sorted, I-9 forms associated with active employees may be delivered to trusted personnel. In turn, the trusted personnel may distribute the I-9 forms to contractees in secure room 200, who enter the data from the I-9 forms using kiosks 102. While the contractees are entering information the I-9 forms, they may notate whether each I-9 form within an indication of “good” or “interesting,” or “problem.” For example, an electronic record for a given I-9 form may be notated as “good” when the I-9 form includes the correct information, in the correct portion of the I-9 form, with the correct supporting documentation. An electronic record for a given I-9 form may be notated as “interesting” if the contractee finds that a given I-9 form has some problem, such rare historical supporting documents or statutory date violations, etc. An electronic record for a given I-9 form may be notated as “problem” if the contractee finds a technical or substantive violation which may be corrected by the employee or employer under strict advisory supervision such that liability for the form is mitigated.

In one embodiment, two electronic records may be generated for each I-9 form of an active employee and separated employees with a separation date of less than the minimum period required for I-9 form retention. The first electronic record may provide a searchable database record with data fields corresponding to each field on the I-9 form that an employee or employer may complete. Once data has been entered for all I-9 forms received at step 305, the firm may search the database to create a variety of reports. For example, a simple query may be used to generate a list of each form notated as “interesting,” allowing attorneys with the firm to conduct a detailed review of each such I-9 form. Similarly, another query may be used to identify electronic records that may be purged, based on an employee separation date and the document retention requirements (i.e., three years or one year from a separation date, whichever is later). As described, the first electronic record may be generated by the data entry process performed by a contractee within secure area 200. The second collection of electronic records may provide a digital image of each original paper I-9 form received at step 305. The second electronic record may be stored using a variety of well known image formats (e.g., BMP, JPG, GIF, PDF, etc).

In one embodiment, I-9 forms notated as “good” may be processed as follows: at step 320, “good” forms may be scanned into the “good” I-9 form mailbox. At step 325, any supporting documents supplied in support of a given “good” I-9 form may be scanned and attached to the image of that I-9 form. At step 365, the original paper copy of the “good” I-9 forms may be shredded. Alternatively, I-9 forms notated as “interesting” or “problem” may be processed as follows: at step 330 the firm scans the forms into the “interesting” mailbox on the server 122. At step 335, a representative of the firm may evaluate a given I-9 form notated as “interesting” or “problem” and annotate the electronic record of that I-9 form regarding the type of error. For example, in one embodiment, the representative may sort the I-9 forms based on an assessment of whether problems in a given I-9 form are correctable. That is, in some cases, the problem with an I-9 form may be corrected. For example, current law allows an employer to correctly document in section 2 of the form I-9 the evidence in support of the employee's section 1 election had the employer mistakenly failed to note required information. In such cases, by taking corrective action, the employer may mitigate potential liability based on an otherwise problematic I-9 form. Additionally, the representative may be an attorney, and thus the notation added to the electronic record may be protected by the general privileges arising from the attorney/client communications. At step 340, the firm may send the employer a CD with images of I-9 forms along with instructions for corrective action. Of course, such information could also be transmitted to the employer over a network.

Alternatively, some errors in an I-9 form may not be correctable. For example, if an I-9 form reflects that the employee is not authorized to work in the United States, it may not be corrected using the process described above. When such an uncorrectable error is identified, the employer has an incentive to take adverse employment action regarding the relevant employee until new I-9 forms are legitimately completed. Accordingly, at step 345 the firm may notate the record as not correctable and send the employer a list of employees with I-9 forms having uncorrectable errors along with a recommendation that the employer take adverse employment action until the employee supplies an acceptable I-9 form with proper documentation.

I-9 forms of employees that are separated from the firm may be processed somewhat differently than I-9 forms of active employees. At step 350, the firm may sort I-9 forms of employees that have been separated from the employer for more than three years. For employees that have been separated less than three years (or less than minimum retention requirement) at step 355, the firm may scan such the forms into the separated employee database 238, creating a digital image of each such I-9 form. Additionally, for each such I-9 form, a database entry may be created that identifies when a given I-9 form may be destroyed.

For I-9 forms representing an employee that has been separated more than three years (or longer than the minimum retention requirement), data entry personnel may enter the employee name, cataloguing number, and date of separation into the separated employee database in step 360. At step 365, all I-9 forms from separated employees may be shredded. Thus, after performing the audit reflected by method 300, all documentation originally sent from the employer is converted to electronic records that include both a digital image and a corresponding database record for each I-9 form received from the employer at step 305.

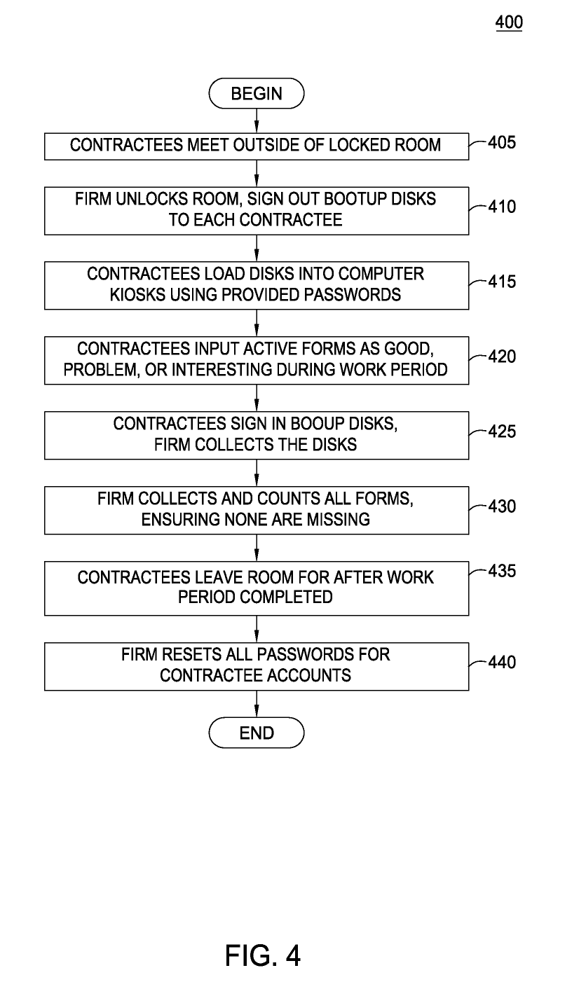

As stated, contractees hired for data entry are exposed to confidential information during the data-entry process performed as part of method 300. Accordingly, to limit the potential for misuse of such information, the firm may take steps involving contractees and secure area 200. For example, FIG. 4 is a flow diagram illustrating a method 400 for a secure data entry process, according to one embodiment of the invention. As shown, the method begins at step 405, where contractees begin a work period outside a locked room, e.g., outside the secure area 200 of FIG. 2. At step 410, trusted personnel may unlock the secure area 200, and distribute a boot CD to each contractee. In one embodiment, each boot CD may be embossed with serialized number, and the trusted personnel may maintain a log reflecting which contractee signed out which serialized boot CD. At step 415, each contractee may use their boot CD with one of the kiosks 102. When the contractee boots kiosk 102 from the boot CD, the software on the boot CD may prompt the contractee for a login and password provided by the firm.

At step 420, once the data entry software is running, the contractees input data from the I-9 forms of active employees and label them as “good,” “problem,” or otherwise “interesting.” At the conclusion of a work period, at step 425, the contractees may sign in their respective boot CDs and the trusted personnel ensure that each serialized boot CD is accounted for. At step 430, the firm collects the I-9 forms in the secure area 200 and ensures that the number of I-9 forms distributed at the beginning of the work period matches the number collected at the end of the work period. At step 430, the contractees exit the secure area 200. Once the contractees have left, the trusted personnel may generate new passwords for each of the boot CDs at step 435. Thus, when the contractees return for the following work period, they are given a different password to use to log into the computer, even if given the same serialized boot CD. Additionally, contractees may consistently be reminded of their confidentiality obligation regarding the I-9 forms and the supporting documents that they are handling and are strictly supervised through the process.

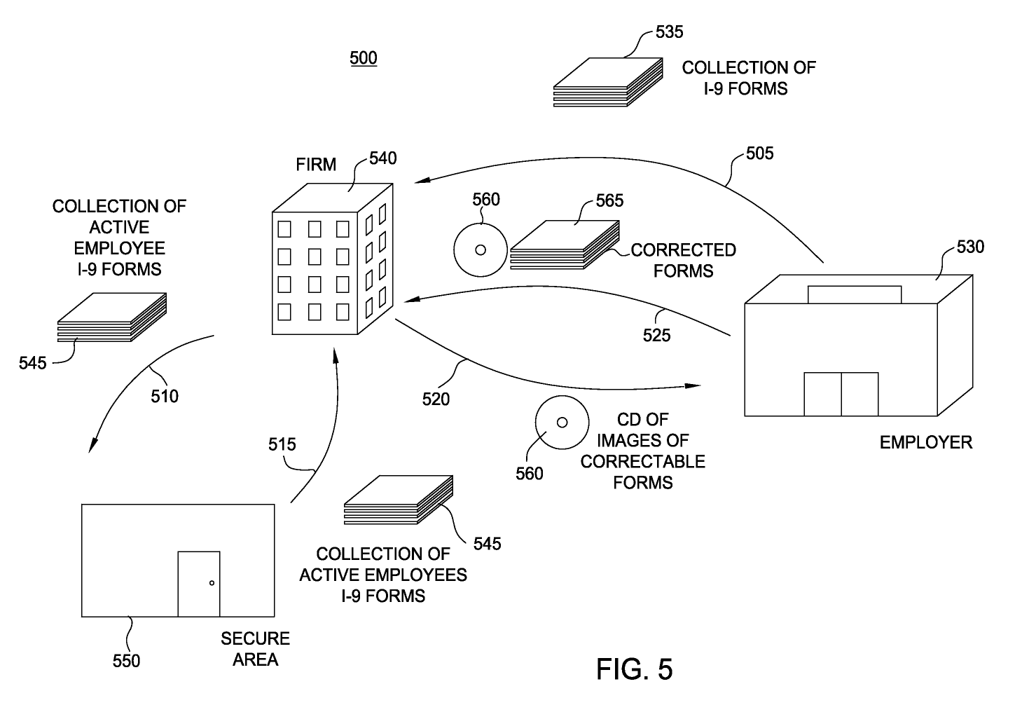

FIG. 5 is a conceptual illustration of document and information flow between an employer 530 and a firm 540, according to one embodiment of the invention. As shown, the employer 530 sends a collection of I-9 forms 535 for both active and separated employees, along with supporting documents (arrow 505) to a firm 540. The firm 540 receives the I-9 forms and separates them into active and separated employees. In one embodiment, the I-9 forms for separated employees are processed within the firm, while the I-9 forms for active employees 545 are sent to the secure area 550 for data entry according to the methods 300 and 400 (arrow 510).

After the contractees enter data for the I-9 forms, the collection of active employee forms 545 are sent back to the firm 540 for scanning and destruction (arrow 515). The firm 540 then evaluates I-9 forms notated as “problem” or “interesting” to identify whether each such form has correctable or uncorrectable errors. In one embodiment, the firm may create a CD 560 storing images of the correctable forms, and instructions for correcting each correctable I-9 form. The firm may send sends the CD back to the employer 530 requesting corrections (arrow 525). The CD 560 may be encrypted to prevent unauthorized access to the confidential I-9 data included on the CD 560. Alternatively, the information stored on CD 560 may be transmitted to the employer using a secure network connection. The employer 530 may hen contact the firm 540 for a password to view the images and instructions regarding the correctable I-9 forms. In one embodiment, the employer 530 may view the classification of the errors on a computer screen using the appropriate image viewing software. That is, the electronic images of a given I-9 form may be displayed with annotations identifying both the error and the recommended mitigation action for that I-9 form. When the images are printed, however, the I-9 may appear as the original paper form, without the annotations. After reviewing the electronic images, the employer 530 may take the corrective action to mitigate the problems associated with some of the I-9 forms. Further, the employer 530 may send a collection of corrected forms 565 along with the CD 560 back to the firm for data entry (arrow 525).

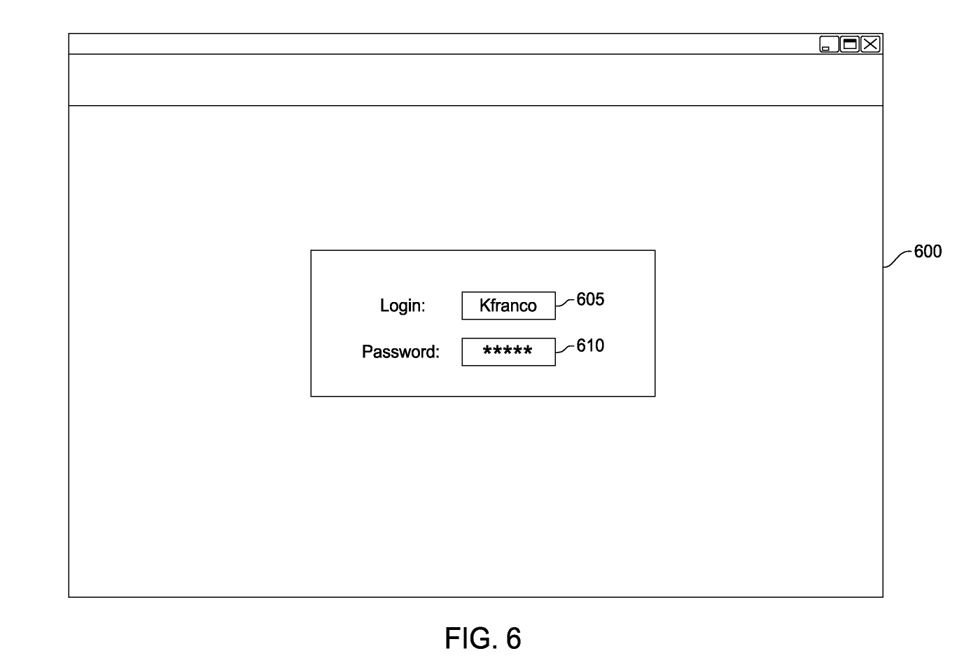

FIG. 6 illustrates a screenshot 600 of a login screen for a data entry terminal, according to one embodiment of the invention. As described, the contractee inserts a boot CD into one of the kiosks 102 in the secure area 200. The boot CD may store an operating system with functionality limited to the data entry software. The data entry software may be configured to prompt the contractee to enter a login name in textbox 605 and a password generated and provided by a firm in textbox 610. In one embodiment, when the boot CD is used to boot one of the kiosks 102, the only functionality provided is the login screen. Further, the data entry software may prevent the contractee from navigating away from the login screen (or performing any computing tasks using kiosk 102) without properly logging into the data entry software.

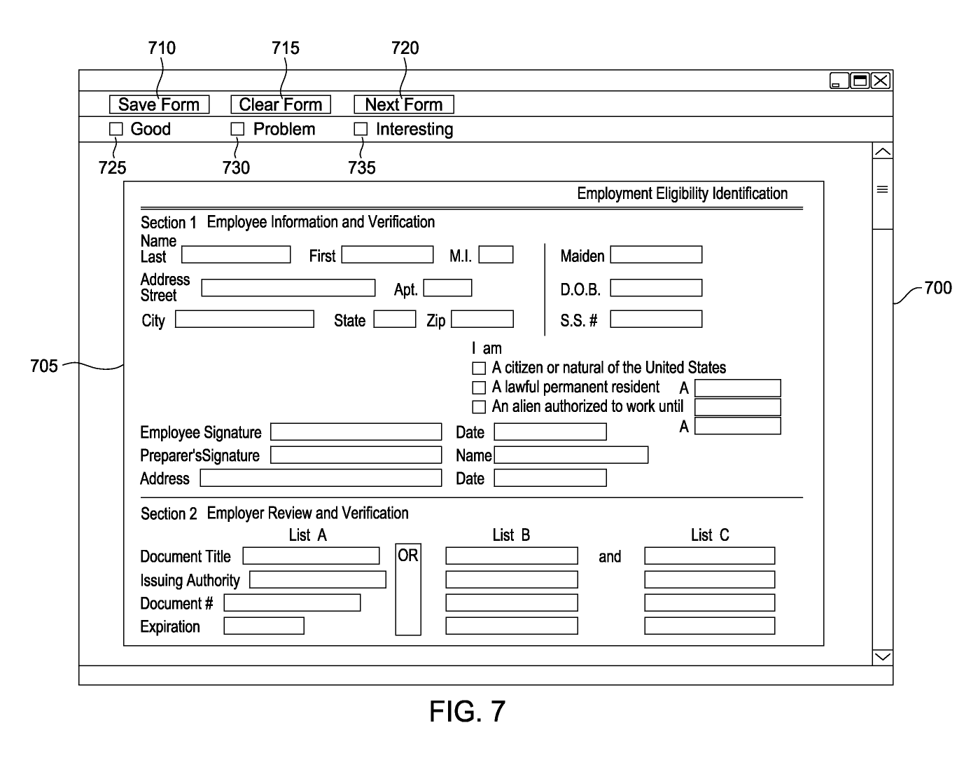

Once the contractee user has successfully logged into the data entry system, the contractee may be provided a data entry screen. FIG. 7 illustrates an example screenshot 700 of a data entry screen, according to one embodiment of the invention. Illustratively, screenshot 700 displays a blank I-9 form 705 with textboxes to be completed by the contractee. As shown, the GUI interface provides contractee with only the functionality required to perform data entry tasks. Specifically, screenshot 700 shows a “Save Form” button 710, a “Clear Form” button 715, and a “Next Form” button 720. Additionally, checkboxes 725, 730, and 735 allow the contractee to notate each I-9 form as “good,” “problem,” or “interesting:” before going on to the next one. After entering data for a given I-9 form, the contractee may choose to save the form and begin entering data for the next one. In one embodiment, as the kiosk 120 lacks permanent storage, the data entered by the contractee is stored on the server 122 in the active employee database 138, either in the “good forms” mailbox 140 or the “interesting & problem forms” mailbox 142, depending on how the contractee has categorized a given I-9 form.

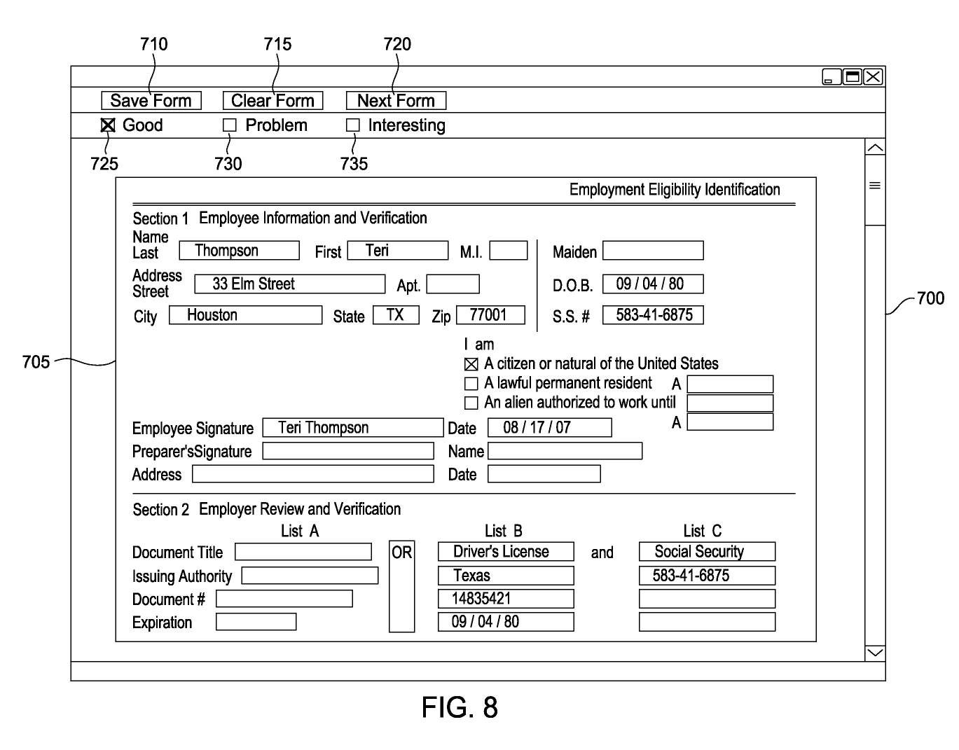

FIG. 8 illustrates an example screenshot of a successfully completed data entry screen, according to one embodiment. In this example, the contractee completed data entry for an I-9 form without encountering any errors or otherwise “interesting” data. Accordingly, the contractee checks the “Good” box 725. Once completed, the contractee saves the form using button 710 and moves on to the next form. The physical form for this type of I-9 would then be scanned into the “good” mailbox 140 and the paper I-9 form (and any supporting documents) may be shredded by the firm.

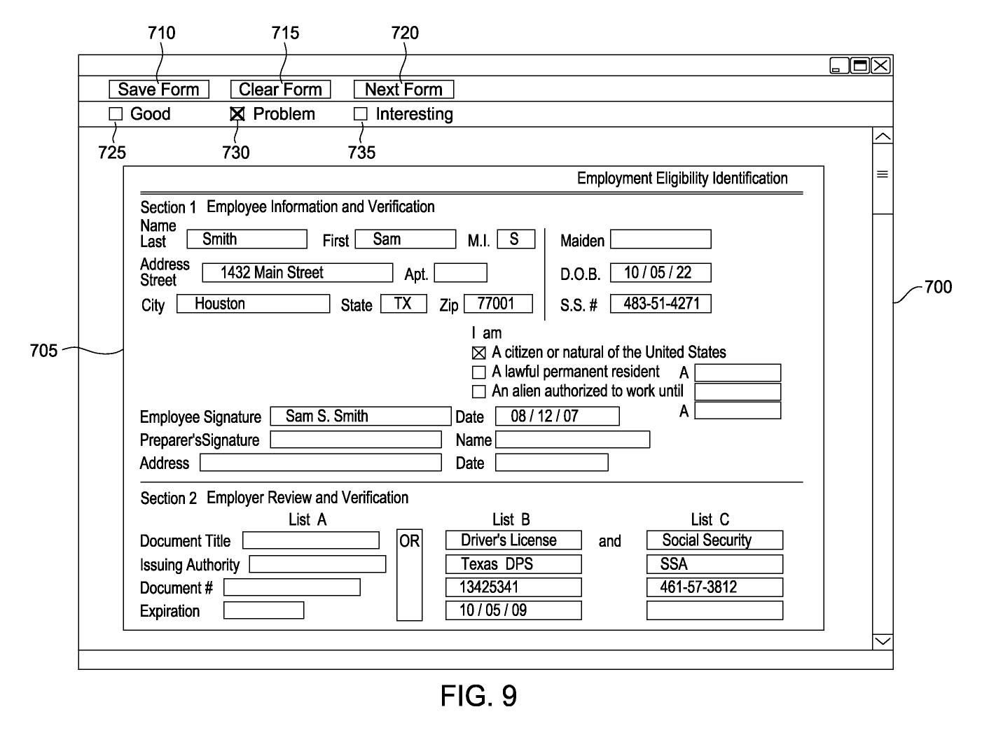

FIG. 9 illustrates an example of a screenshot for a problem I-9 form, according to one embodiment. In this example, the social security numbers listed in Section 1 and Section 2 do not match. In this case, the contractee checks the “Problem” box 730 before moving on to the next form. The physical version of this I-9 form would then be scanned into the “interesting & problem” mailbox 142 in the active employee database l38. Firm personnel would then review the digital version of the I-9 form to evaluate what errors are present, and what, if any, corrective mitigation action may be taken. When the firm reviews the problem I-9 form illustrated in FIG. 9, firm personnel may comment on the type of errors that were found.

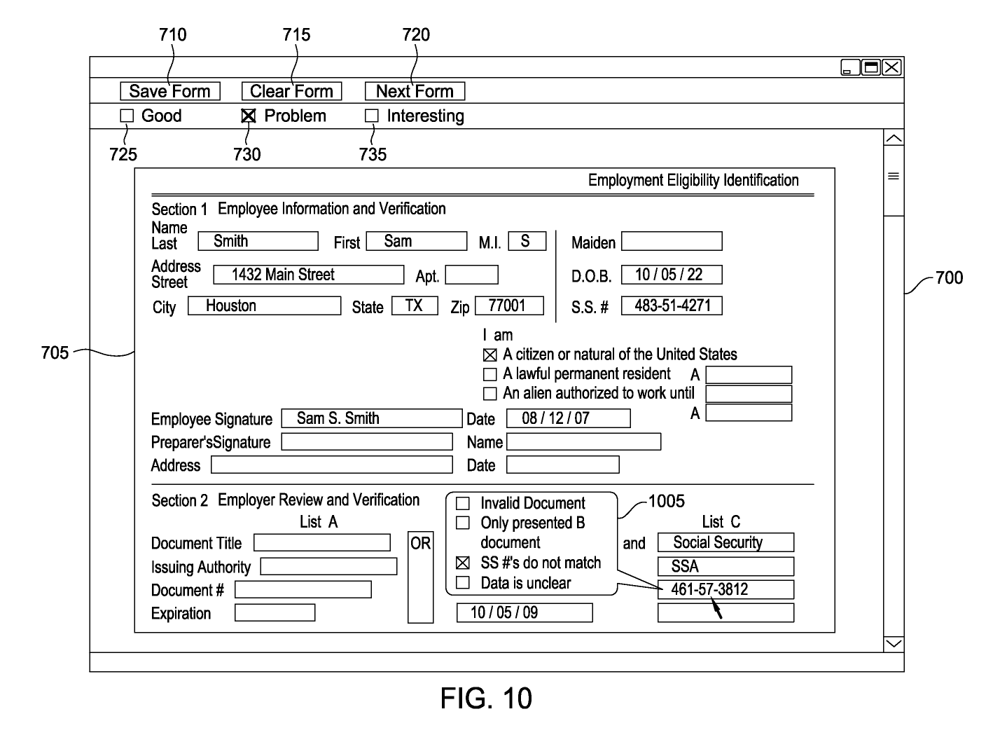

FIG. 10 illustrates an example of the screenshot of the problem I-9 form from FIG. 9 after being notated to indicate a specified error, according to one embodiment of the invention. In this example, the firm representative has clicked on a textbox where an error was found. In one embodiment, the software used by the firm representative displays a comment bubble 1005 with a series of options for what the error may be. Illustratively, the firm representative checked that the social security numbers do not match between Section 1 and Section 2 on the I-9 form. This error may be so problematic that it is not correctable. In that case, the firm representative may recommend the employer to take adverse employment action against the employee that has submitted the form, until the errors in the form are remedied.

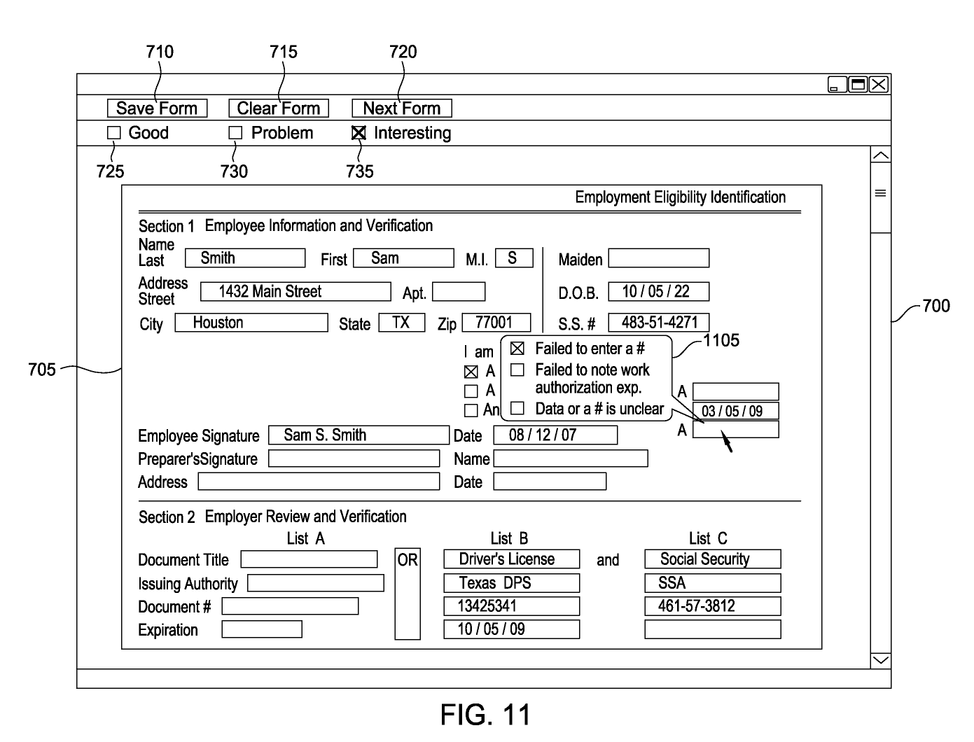

FIG. 11 illustrates an example screenshot of an I-9 form after being notated to indicate a potential inaccuracy, according to one embodiment of the invention. In this example, the error was found in Section 1. Again, a representative for the firm has clicked on a text box where the error was found to bring up a comment bubble. In this example, the comment bubble 1105 shows a different series of options for possible errors than comment bubble 1005 in FIG. 10. In one embodiment, the errors listed correspond to particular section of the I-9 form which the comment bubble is linked. In this example, the firm representative has selected that the employee failed to enter a number required for this I-9 form to be compete. This type of error may simply be an oversight and may be categorized as a correctable error. Thus, as described above, the firm may store a digital image of the original I-9 form on a CD along with mitigation instructions sent to the employer.

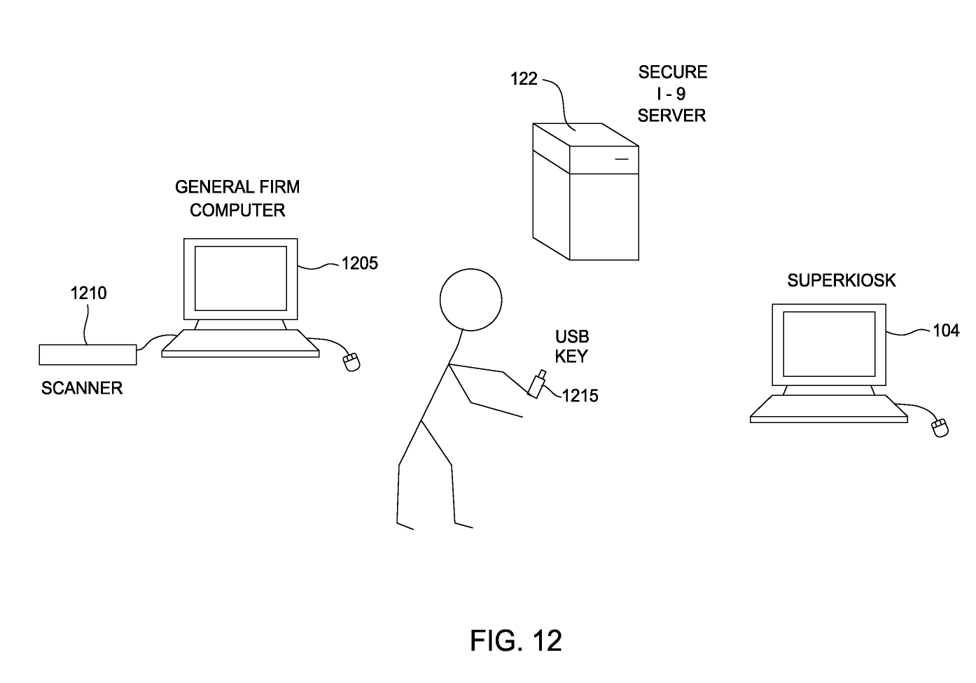

When the forms are sent to the firm to be scanned, the scanning may be done by a scanner and computer outside the secured area 200. Typically however, scanning is performed by trusted firm personnel. FIG. 12 illustrates the process of transporting digital versions of scanned I-9 forms from a general computer to the secured server, according to one embodiment of the invention. Once a firm representative has scanned the I-9 images using a firm scanner 1210 and a general firm computer 1205, the images are saved directly to a USB key 1215. The USB keys for a firm are serialized and checked out to trusted firm personnel, much like the boot CDs described above, so that once they are released, the firm may track who is in possession of each USB key. The USB key is then taken into the secured area 200 and inserted into one of the super-kiosks 104. The firm personnel may then upload the scanned images from the super-kiosk 104 into either the active employee database 138 or the separated employee database 132 on the secure server 122. The key is then erased and checked in to prevent further exposure of the data.

Advantageously, as described herein, embodiments may be used to mitigate potential liability for non-compliance with legal requirements related to employment authorization and verification. In one embodiment, a method is used to digitize I-9 forms, to create a database of the information reflected in the paper I-9 forms, and to identify errors in the I-9 forms, while concurrently limiting both the potential for unwanted disclosure of employee personal data and the potential for increased employer liability due to “knowledge” of problematic or incorrect I-9 form data. I-9 forms and supporting documents may be collected and delivered to a legal services entity (e.g., a law firm). Representatives of the law firm may sort the I-9 forms by active and separated employees, scan the forms to create an electronic copy of the forms, and enter the form data for each I-9 form into a secure database. Further, the entire process of may be performed within a secure environment, minimizing the potential for the misuse of identifying personal information reflected in the forms. After the I-9 forms are digitized, the paper copies may be destroyed.

While the foregoing is directed to embodiments of the present invention, other and further embodiments may be devised without departing from the basic scope thereof, and the scope thereof is determined by the claims that follow.

1. A method for mitigating an employer's potential liability exposure based on errors in regulatory documents required to be kept by the employer, the method comprising:
receiving a plurality of documents, wherein each document corresponds to an employee of the employer and includes personally identifying information related to the employee;
generating at least one electronic record for each of the plurality of documents, wherein the electronic record captures the information recorded on one of the plurality of documents related to one of the employees;
evaluating the information for compliance with a regulatory requirement imposed on the employer;
for each electronic record representing one of the documents with information determined to comply with the regulatory requirement, storing the electronic record in a first collection of electronic records determined to comply with the regulatory requirement; and
for each electronic record representing one of the documents with information determined to not comply with the regulatory requirement:
identifying an error in the information of the electronic records,
determining whether the error in the information may be mitigated through a corrective action performed by the employer,
if the error may be mitigated, storing the electronic record in a second collection of electronic records along with a recommendation for a corrective action to be performed by the employer.

2. The method of claim 1, wherein the method further comprises:
storing the electronic records included in the first collection of electronic records determined to comply with the regulatory requirement on a first computer readable storage medium; and
storing the electronic records included in the second collection of electronic records determined to comply with the regulatory requirement on a second computer readable storage medium.

3. The method of claim 2, wherein the electronic records stored on the first computer readable storage medium and the second computer readable storage medium are stored in an encrypted format.

4. The method of claim 2, further comprising transmitting the first and second computer readable storage medium to the employer.

5. The method of claim 1, further comprising destroying the plurality of documents.

6. The method of claim 1, wherein generating one or more electronic records for a given document comprises generating a first electronic record as a digital image of the given document and a second electronic record as a database record storing the captured information.

7. The method of claim 1, wherein the personally identifying information is used to vet an employee's authorization to work for the employer.

8. The method of claim 1, wherein the document corresponding to a given employee further includes additional supporting documents.

9. The method of claim 1, wherein each of the plurality of documents includes a portion originally completed by the employee represented in the document and a portion completed by the employer.

10. The method of claim 1, wherein the personally identifying information includes at least a social security number of an employee.

11. The method of claim 1, further comprising, separating the plurality of documents into a first set of documents representing employees then actively employed by the employer and a second collection of documents representing employees then separated from employment with the employer.

12. A system for mitigating an employer's potential liability exposure based on errors in regulatory documents required to be kept by the employer, the system comprising:
a secure room;
a plurality of computing devices, wherein each computing device includes:
a processor,
a memory, and
a read-only storage device, containing a serialized computer readable storage medium, wherein the computer readable storage medium includes an operating system configured to boot the computing device and to initiate a data entry program, wherein the data-entry program, when executed on the processor, is configured to:
present a data entry screen for capturing information from each of a plurality of the regulatory documents required to be kept by the employer,
receive input data capturing the information for a given one of the plurality of the regulatory documents,
generate an electronic record storing the captured information from the given regulatory document,
notate the electronic record with an indication of whether the information captured from the given document is believed to be in compliance with the regulatory requirement imposed on the employer, and
transmit the electronic record to a database.

13. The system of claim 12, further comprising:
a second computing device, wherein the second computing device includes:
a processor; and
a memory containing a viewing program, which when executed on the processor is configured to:
present a display of one of the electronic records;
receive a selection of a determination of whether the captured information in the electronic record is in compliance with the regulatory requirement imposed on the employer,
for each electronic record representing one of the documents with information determined to comply with the regulatory requirement, store the electronic record in a first collection of electronic records determined to comply with the regulatory requirement, and
for each electronic record representing one of the documents with information determined to not comply with the regulatory requirement:
to receive a selection of an error in the captured information of the electronic records and an indication of whether the error in the captured information may be mitigated through a corrective action performed by the employer,
if the error may be mitigated, store the electronic record in a second collection of electronic records along with a recommendation for a corrective action to be performed by the employer, and
if the error may not be mitigated, store the electronic record in a third collection of electronic records along with a recommendation that the employer take an adverse employment with respect to the employee.

14. The system of claim 13, wherein the viewing program is further configured to:
store the electronic records included in the first collection of electronic records determined to comply with the regulatory requirement on a first computer readable storage medium;
store the electronic records included in the second collection of electronic records determined to comply with the regulatory requirement on a second computer readable storage medium; and
store the electronic records included in the third collection of electronic records determined to comply with the regulatory requirement on a third computer readable storage medium.

15. The system of claim 14, wherein the electronic records stored on the third computer readable storage medium are stored in an encrypted format.

16. The system of claim 14, wherein the first, second, and third computer readable storage mediums are transmitted to the employer.

17. The system of claim 14, wherein the plurality of documents are destroyed subsequent to the generation of the electronic records.

18. The system of claim 12, wherein the one or more electronic records for a given document include a first electronic record as a digital image of the given document and a second electronic record as a database record storing the captured information.

19. The system of claim 12, wherein the personally identifying information is used to vet an employee's authorization to work for the employer.

20. The system of claim 12, wherein the document corresponding to a given employee further includes additional supporting documents.
